(19) United States
(12) Patent Application Publication
(10) Pub. No.: US 2026/0002063 A1
(43) Pub. Date: Jan. 1, 2026

(54) CMP POLISHING LIQUID, CMP POLISHING LIQUID SET, AND POLISHING METHOD

(71) Applicant: Resonac Corporation, Tokyo (JP)

(72) Inventors: Yasushi KURATA, Tokyo (JP); Masahiro KANNO, Tokyo (JP); Tomohiro IWANO, Tokyo (JP); Noriaki MURAKAMI, Tokyo (JP); Makoto MIZUTANI, Tokyo (JP); Shigeki KUBOTA, Tokyo (JP); Taira ONUMA, Tokyo (JP)

(21) Appl. No.: 18/857,736

(22) PCT Filed: Aug. 7, 2023
(86) PCT No.: PCT/JP2023/028806

§ 371 Date: Oct. 17, 2024

(30) Foreign Application Priority Data
Nov. 21, 2022 (WO) PCT/JP2022/043063

(51) Int. Cl. C09K 3/14; B24B 37/04; C09K 13/00

(52) U.S. Cl. CPC C09K 3/1463; B24B 37/044; C09K 13/00

(57) ABSTRACT

A polishing liquid for CMP, containing: abrasive grains; an additive; and water, in which the abrasive grains include cerium-based particles, a zeta potential of the abrasive grains is negative, the additive includes (A1) a 4-pyrone-based compound represented by General Formula (1) below, and a pH is 5.0 or more. A polishing liquid for CMP, containing: abrasive grains; an additive; and water, in which the abrasive grains include cerium-based particles, a zeta potential of the abrasive grains is negative, the additive includes (A2) a picolinic acid compound, and a pH is 5.0 or more.

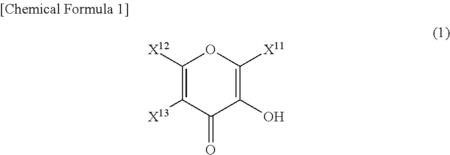

[In the formula, X¹¹, X¹², and X¹³ are each independently a hydrogen atom or a monovalent substituent.]

### TECHNICAL FIELD

The present disclosure relates to a polishing liquid for CMP (chemical mechanical polishing), a polishing liquid set for CMP, a polishing method, and the like.

### BACKGROUND ART

In the field of semiconductor production, with achievement of high performance of ultra LSI devices, a miniaturization technology as an extension of the conventional technology finds restriction in allowing high integration and speed-up to be compatible with each other. Accordingly, techniques for allowing vertical high integration (namely, techniques for developing multilayered wiring) while miniaturization of semiconductor elements have been developed.

In the process for manufacturing a device including multilayered wiring, one of the most important techniques is a CMP technique. The CMP technique is a technique that flattens a surface of a base substrate obtained by forming a thin film on a substrate by chemical vapor deposition (CVD) or the like. For example, a flattening treatment by CMP is essential to ensure the depth of focus in lithography. When the surface of the base substrate has irregularities, there occur, for example, such troubles that the focusing in an exposure step is precluded, and a fine wiring structure cannot be sufficiently formed. Furthermore, the CMP technique is also applied to the step of forming element isolation (isolation between elements; STI: shallow trench isolation) regions by polishing of plasma oxide films (such as BPSG, HDP-SiO₂, and p-TEOS); the step of forming an ILD film (interlayer insulating film; an insulating film electrically insulating metal members (wirings and the like) in the same layer); the step of flattening plugs (for example, Al or Cu plugs) after embedding a film containing silicon oxide in a metal wiring; and the like in device manufacturing process.

CMIP is usually performed using an apparatus capable of supplying a polishing liquid onto a polishing pad. Further, the surface of a base substrate is polished by pressing the base substrate against the polishing pad while a polishing liquid is supplied between the surface of the base substrate and the polishing pad. As described above, in the CIP technique, a polishing liquid is one of elemental technologies, and various polishing liquids have also been hitherto developed in order to obtain a high-performance polishing liquid (see, for example, Patent Literature 1 below).

Among the steps to which the CIP technique as mentioned above is applied, particularly, in the CIP step for the ILD film, it is necessary to polish silicon oxide at a high polishing rate. Therefore, in the CMIP step for the ILD film, a silica-based polishing liquid (a polishing liquid using abrasive grains including silica-based particles) having a high polishing rate is mainly used (see, for example, Patent Literature 2 below). However, in the silica-based polishing liquid, it tends to be difficult to control polishing scratches which cause defects. Furthermore, with the recent miniaturization of wirings, it is desirable to reduce polishing scratches in the CMIP step for the ILD film, but unlike the CMP step for an insulating film for an element isolation region, final mirror polishing is generally not performed. Therefore, the use of a cerium-based polishing liquid (a polishing liquid using abrasive grains including cerium-based particles), which causes fewer polishing scratches than the silica-based polishing liquid, is being studied (see, for example, Patent Literature 3 below).

### CITATION LIST

### Patent Literature

Patent Literature 1: Japanese Unexamined Patent Publication No. 2008-288537
Patent Literature 2: Japanese Unexamined Patent Publication No. H9-316431
Patent Literature 3: Japanese Unexamined Patent Publication No. H10-102038

### SUMMARY OF INVENTION

### Technical Problem

When a surface to be polished is polished by using abrasive grains, it is required that the abrasive grains are less likely to remain on a polished surface after polishing. Here, since there is a tendency that silicon oxide of a material to be polished has a negative zeta potential, in a case where a surface to be polished containing silicon oxide is polished by using abrasive grains having a negative zeta potential, the abrasive grains are less likely to remain on a polished surface after polishing due to the electrostatic repulsion between the abrasive grains and the surface to be polished. On the other hand, since the polishing rate is difficult to be improved due to the electrostatic repulsion between the abrasive grains and the surface to be polished, in the case of using abrasive grains having a negative zeta potential, there is a case where it is difficult to achieve a high polishing rate for silicon oxide. Further, according to the findings of the present inventor, when abrasive grains having a negative zeta potential are used, although a high polishing rate for silicon oxide in polishing of a blanket wafer having no concavo-convex pattern is achieved, there is a case where it is difficult to achieve a high polishing rate for silicon oxide of a convex portion in polishing of a pattern wafer having a concavo-convex pattern configured by a convex portion (for example, Line portion) and a concave portion (for example, Space portion). Therefore, it is required for a polishing liquid for CMP using abrasive grains having a negative zeta potential to achieve a high polishing rate for silicon oxide of a convex portion in polishing of a pattern wafer having a concavo-convex pattern.

Furthermore, in a polishing liquid for CP using abrasive grains having a negative zeta potential, there is a case where the phenomenon of precipitation of the abrasive grains is confirmed over time after the preparation of the polishing liquid for CP. Therefore, it is required for a polishing liquid for CP using abrasive grains having a negative zeta potential to achieve excellent dispersion stability of the abrasive grains.

An object of an aspect of the present disclosure is to provide a polishing liquid for CP using abrasive grains having a negative zeta potential, the polishing liquid for CP being capable of achieving a high polishing rate for silicon oxide of a convex portion in polishing of a pattern wafer having a concavo-convex pattern while achieving excellent dispersion stability of the abrasive grains. Furthermore, an object of another aspect of the present disclosure is to provide a polishing liquid set for CP for obtaining the above-described polishing liquid for CP. Further, an object of another aspect of the present disclosure is to provide a polishing method which uses the above-described polishing liquid for CP or the above-described polishing liquid set for CP.

### Solution to Problem

The present disclosure relates to the following [1] to [19] and the like in several aspects.

[1] A polishing liquid for CMP, containing: abrasive grains; an additive; and water, in which the abrasive grains include cerium-based particles, a zeta potential of the abrasive grains is negative, the additive includes (A1) a 4-pyrone-based compound represented by General Formula (1) below, and a pH is 5.0 or more:

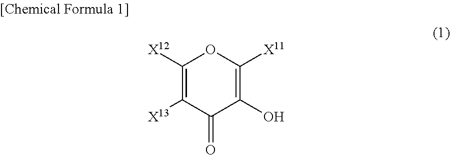

[in the formula, X¹¹, X¹², and X¹³ are each independently a hydrogen atom or a monovalent substituent.]

[2] The polishing liquid for CMP described in [1], in which the component (A1) includes at least one selected from the group consisting of 3-hydroxy-2-methyl-4-pyrone, 5-hydroxy-2-(hydroxymethyl)-4-pyrone, and 2-ethyl-3-hydroxy-4-pyrone.

[3] The polishing liquid for CMP described in [1] or [2], in which a content of the component (A1) is 0.001 to 5% by mass.

[4] The polishing liquid for CP described in any one of [1] to [3], in which the additive further includes (B) a compound having two or more nitrogen atoms to which a hydroxyalkyl group is bonded.

[5] The polishing liquid for CP described in [4], in which the component (B) includes an ethylenedinitrilotetraethanol.

[6] The polishing liquid for CP described in any one of [1] to [5], in which the pH is 8.0 or less.

[7] A polishing liquid for CMP, containing: abrasive grains; an additive; and water, in which the abrasive grains include cerium-based particles, a zeta potential of the abrasive grains is negative, the additive includes (A2) a picolinic acid compound, and a pH is 5.0 or more.

[8] The polishing liquid for CP described in [7], in which the component (A2) includes picolinic acid.

[9] The polishing liquid for CP described in [7] or [8], in which the component (A2) includes hydroxypicolinic acid.

[10] The polishing liquid for CP described in any one of [7] to [9], in which the component (A2) includes aminopicolinic acid.

[11] The polishing liquid for CMP described in any one of [7] to [10], in which a content of the component (A2) is 0.001 to 5% by mass.

[12] The polishing liquid for CP described in any one of [7] to [11], in which the additive further includes (B) a compound having two or more nitrogen atoms to which a hydroxyalkyl group is bonded.

[13] The polishing liquid for CMP described in [12], in which the component (B) includes an ethylenedinitrilotetraethanol.

[14] The polishing liquid for CP described in any one of [7] to [13], in which the pH is 8.0 or less.

[15] A polishing liquid set for CMP, containing: constituent components of the polishing liquid for CP described in any one of [1] to [14], separately stored as a first liquid and a second liquid, in which the first liquid contains the abrasive grains and water, and the second liquid contains at least one of the additive, and water.

[16] A polishing method including a step of polishing a surface to be polished by using the polishing liquid for CMP described in any one of [1] to [14].

[17] The polishing method described in [16], in which the surface to be polished contains silicon oxide.

[18] A polishing method including a step of polishing a surface to be polished by using a polishing liquid for CMP obtained by mixing the first liquid and the second liquid of the polishing liquid set for CP described in [15].

[19] The polishing method described in [18], in which the surface to be polished contains silicon oxide.

### Advantageous Effects of Invention

According to an aspect of the present disclosure, it is possible to provide a polishing liquid for CMP using abrasive grains having a negative zeta potential, the polishing liquid for CP being capable of achieving a high polishing rate for silicon oxide of a convex portion in polishing of a pattern wafer having a concavo-convex pattern while achieving excellent dispersion stability of the abrasive grains. Furthermore, according to another aspect of the present disclosure, it is possible to provide a polishing liquid set for CP for obtaining the above-described polishing liquid for CP. Further, according to another aspect of the present disclosure, it is possible to provide a polishing method which uses the above-described polishing liquid for CMP or the above-described polishing liquid set for CMP.

### BRIEF DESCRIPTION OF DRAWINGS

FIG. 1 is a schematic cross-sectional view illustrating the process of polishing an ILD film.

### DESCRIPTION OF EMBODIMENTS

Hereinafter, an embodiment of the present disclosure will be described in detail.

In the present specification, a numerical range that has been indicated by use of “to” indicates the range that includes the numerical values which are described before and after “to”, as the minimum value and the maximum value, respectively. “A or more” in a numerical range means A and a range of more than A. “A or less” in a numerical range means A and a range of less than A. In numerical ranges that are described stepwise in the present specification, the upper limit value or the lower limit value of the numerical range of a certain stage can be arbitrarily combined with the upper limit value or the lower limit value of the numerical range of another stage. In numerical ranges that are described in the present specification, the upper limit value or the lower limit value of the numerical range may be replaced with the value shown in Examples. “A or B” may include either one of A and B, and may also include both of A and B. Materials listed as examples in the present specification can be used singly or in combinations of two or more kinds, unless otherwise specified. When a plurality of substances corresponding to each component exist in the composition, the content of each component in the composition means the total amount of the plurality of substances that exist in the composition, unless otherwise specified. The term “layer” or “film” includes a structure having a shape which is formed on a part, in addition to a structure having a shape which is formed on the whole surface, when the film has been observed as a plan view. The term “step” includes not only an independent step but also a step by which an intended action of the step is achieved, though the step cannot be clearly distinguished from other steps.

### <Polishing Liquid for CMP>

A polishing liquid for CMP of the present embodiment (a first embodiment and a second embodiment; the same applies hereinafter) is a polishing liquid for CMP (hereinafter, simply referred to as “polishing liquid” in some cases) containing abrasive grains, an additive, and water. The abrasive grains include cerium-based particles (particles containing a cerium-based compound), and the zeta potential of the abrasive grains is negative. The additive of the polishing liquid of the first embodiment includes (A1) a 4-pyrone-based compound represented by General Formula (1) below (component (A1)). The additive of the polishing liquid of the second embodiment includes (A2) a picolinic acid compound (component (A2)). The additive of the polishing liquid of the present embodiment may include the component (A1) and the component (A2). The pH of the polishing liquid of the present embodiment is 5.0 or more.

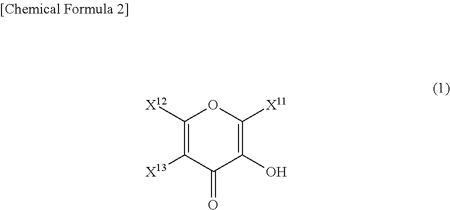

[In the formula, X¹¹, X¹², and X¹³ are each independently a hydrogen atom or a monovalent substituent.]

According to the polishing liquid of the present embodiment, it is possible to achieve a high polishing rate for silicon oxide of a convex portion in polishing of a pattern wafer having a concavo-convex pattern configured by a convex portion (for example, Line portion) and a concave portion (for example, Space portion), and for example, it is possible to achieve a high polishing rate for silicon oxide of a convex portion in polishing of a region with Line/Space (L/S)=20 μm/80 μm of a pattern wafer. According to the polishing liquid of the present embodiment, in the evaluation method described in Examples described below, as a polishing rate for silicon oxide of a convex portion in a region with L/S=20 μm/80 μm, for example, 200 nm/min or more (preferably, 250 nm/min or more, 300 nm/min or more, 350 nm/min or more, 400 nm/min or more, 500 nm/min or more, or the like) can be obtained.

According to the polishing liquid of the present embodiment, excellent dispersion stability of the abrasive grains can be achieved. According to the polishing liquid of the present embodiment, in the evaluation method described in Examples described below, as a change rate of the average particle diameter of the abrasive grains after a lapse of 3 hours, for example, 4% or less can be obtained.

Although a factor responsible for these effects is not necessarily clear, the factor is speculated as described below. However, the factor is not limited to the contents to be as follows.

That is, in a case where a surface to be polished containing silicon oxide is polished by using abrasive grains having a negative zeta potential, there is a case where it is difficult to achieve a high polishing rate for silicon oxide due to the electrostatic repulsion between the abrasive grains and the surface to be polished. On the other hand, according to the polishing liquid of the present embodiment, by using the component (A1) or the component (A2) together with the cerium-based particles, actions of easily increasing an interaction between the cerium-based particles and silicon oxide (for example, easily promoting a chemical reaction between the cerium-based particles in the polishing liquid and silicon oxide of a convex portion (reaction derived from a Si—O—Ce bond)), easily suppressing the electrostatic repulsion between the abrasive grains and the surface to be polished by reducing an absolute value of a negative charge of a surface to be polished containing silicon oxide, and the like can be obtained. Therefore, in polishing of a pattern wafer, a polishing rate according to a pressure to be applied to a convex portion is easily obtained, so that a high polishing rate for silicon oxide of a convex portion can be achieved.

Furthermore, when the pH is low in a case where the component (A1) or the component (A2) is used together with the cerium-based particles, there is a case where excellent dispersion stability of the abrasive grains cannot be achieved. On the other hand, according to the polishing liquid of the present embodiment, when the pH is 5.0 or more, the zeta potential of the abrasive grains is easily maintained negative in a range in which the electrostatic repulsion between the abrasive grains and the surface to be polished does not become excessively strong, and the electrostatic repulsion between the abrasive grains is easily maintained favorable, so that excellent dispersion stability of the abrasive grains can be achieved.

The polishing liquid can be used to flatten a surface to be polished by polishing a pattern wafer having a concavo-convex pattern to remove a convex portion. In this case, from the viewpoint of obtaining high flatness, and the viewpoint of shortening a polishing time necessary for flattening, there is a case where it is required to achieve a high polishing rate ratio of silicon oxide of a convex portion of a pattern wafer having a concavo-convex pattern with respect to silicon oxide of a blanket wafer having no concavo-convex pattern. However, when abrasive grains having a negative zeta potential are used, because of the fact that the polishing rate is difficult to be improved due to the electrostatic repulsion between the abrasive grains and the convex portion, and the like, there is a case where such a high polishing rate ratio is difficult to be achieved.

According to an embodiment of the polishing liquid of the present embodiment, it is possible to achieve a high polishing rate ratio of silicon oxide of a convex portion of a pattern wafer having a concavo-convex pattern with respect to silicon oxide of a blanket wafer having no concavo-convex pattern, and for example, it is possible to achieve a high polishing rate ratio of silicon oxide of a convex portion in a region with Line/Space (L/S)=20 μm/80 μm of a pattern wafer with respect to silicon oxide of a blanket wafer having no concavo-convex pattern. According to an embodiment of the polishing liquid of the present embodiment, in the evaluation method described in Examples described below, as a polishing rate ratio of silicon oxide of a convex portion in a region with L/S=20 μm/80 μm of a pattern wafer with respect to silicon oxide of a blanket wafer, for example, 0.70 or more (preferably, 0.90 or more, 1.00 or more, 1.50 or more, 2.00 or more, or the like) can be obtained. By obtaining a high polishing rate ratio of silicon oxide of a convex portion of a pattern wafer having a concavo-convex pattern with respect to silicon oxide of a blanket wafer having no concavo-convex pattern, high flatness can be realized as a property capable of selectively polishing a convex portion.

According to an embodiment of the polishing liquid of the present embodiment, it is possible to achieve a high polishing rate for silicon oxide of a convex portion in polishing of a region with L/S=20 μm/80 μm of a pattern wafer while achieving high-rate polishing of silicon oxide of a blanket wafer having no concavo-convex pattern. According to an embodiment of the polishing liquid of the present embodiment, in the evaluation method described in Examples described below, as a polishing rate for silicon oxide of a blanket wafer, for example, 40 nm/min or more (preferably, 50 nm/min or more, 80 nm/min or more, 100 nm/min or more, 150 nm/min or more, 200 nm/min or more, 300 nm/min or more, or the like) can be obtained.

In the step of forming an element isolation region, there is a case where it is required to suppress the polishing rate for a silicon nitride film to be used as a base stopper of a silicon oxide film, and there is a case where high polishing selectivity of silicon oxide with respect to silicon nitride (the polishing rate for silicon oxide/the polishing rate for silicon nitride) is required. According to an embodiment of the polishing liquid of the present embodiment, a sufficiently low polishing rate for silicon nitride can be obtained, and high polishing selectivity of silicon oxide with respect to silicon nitride can be obtained. In this case, it is suitable for polishing when an element isolation region is formed. According to an embodiment of the polishing liquid of the present embodiment, in the evaluation method described in Examples described below, as a polishing rate for silicon nitride of a blanket wafer, for example, 100 nm/min or less (preferably, 50 nm/min or less, 30 nm/min or less, 10 nm/min or less, 5 nm/min or less, or the like) can be obtained.

The polishing liquid of the present embodiment can be used for CP of a semiconductor wafer material, and can be used, for example, for polishing a silicon oxide film provided on a surface of a semiconductor wafer. The polishing liquid of the present embodiment can be used in the CMP step for the ILD film. According to an embodiment of the polishing liquid of the present embodiment, while obtaining a high polishing rate, it is possible to suppress the aggregation of the abrasive grains and the occurrence of polishing scratches and to obtain high flatness.

### (Abrasive Grains)

In the polishing liquid of the present embodiment, the abrasive grains include cerium-based particles (particles containing a cerium-based compound). By using cerium-based particles as abrasive grains, it is easy to obtain a high polishing rate for silicon oxide of a convex portion of a pattern wafer while reducing polishing scratches on a polished surface.

Examples of the cerium-based compound of the cerium-based particles include cerium oxide, cerium hydroxide, cerium ammonium nitrate, cerium acetate, cerium sulfate hydrate, cerium bromate, cerium bromide, cerium chloride, cerium oxalate, cerium nitrate, and cerium carbonate. The cerium-based particles may contain cerium oxide from the viewpoint of easily obtaining a high polishing rate for silicon oxide of a convex portion (convex portion in a region with L/S=20 μm/80 μm, or the like; the same applies hereinafter) of a pattern wafer and the viewpoint of easily obtaining a polished surface having fewer polishing scratches and excellent flatness. The cerium oxide may be CeO₂ (cerium(IV) oxide, ceria), and may be Ce₂O₃ (cerium(III) oxide).

The cerium oxide particles (particles containing cerium oxide) may contain polycrystalline cerium oxide having a grain boundary. Particles containing polycrystalline cerium oxide have a property that active planes appear one after another at the same time when the particles become finer during polishing, and can keep a high polishing rate for silicon oxide of a convex portion of a pattern wafer.

Examples of the method for producing the cerium oxide particles include a firing method; and an oxidation method using hydrogen peroxide or the like. In the case of firing, the temperature during firing may be 350 to 900° C. In a case where the cerium oxide particles aggregate, the particles may be mechanically pulverized. The pulverizing method may be, for example, dry pulverization with a jet mill or the like; or wet pulverization with a planetary bead mill or the like. For the jet mill, for example, a jet mill described in “Kagaku Kougaku Ronbunshu (Collection of chemical engineering papers)”, Vol. 6, No. 5, (1980), pp. 527 to 532 can be used.

The zeta potential (surface potential) of the abrasive grains in the polishing liquid is negative (the zeta potential is less than 0 mV). The zeta potential of the abrasive grains may be −1 mV or less, −5 mV or less, −10 mV or less, −20 mV or less, −30 mV or less, −40 mV or less, −45 mV or less, −50 mV or less, or −55 mV or less. The zeta potential of the abrasive grains may be −100 mV or more, −90 mV or more, −80 mV or more, −70 mV or more, −60 mV or more, −55 mV or more, −50 mV or more, or −45 mV or more. From these viewpoints, the zeta potential of the abrasive grains may be −100 mV or more and less than 0 mV, −80 mV or more and less than 0 mV, −60 mV or more and less than 0 mV, −100 mV to −20 mV, −80 mV to −20 mV, −60 mV to −20 mV, −100 mV to −40 mV, −80 mV to −40 mV, or −60 mV to −40 mV.

The zeta potential of the abrasive grains can be measured, for example, by using a dynamic light scattering type zeta potential measurement apparatus (for example, trade name: DelsaNano C manufactured by Beckman Coulter, Inc.). The zeta potential of the abrasive grains can be adjusted using an additive. For example, by bringing an anionic dispersant into contact with abrasive grains, abrasive grains having a negative zeta potential can be obtained. Examples of the anionic dispersant include a polymer having at least one selected from the group consisting of a carboxy group and a carboxylate group; and ammonium dihydrogen phosphate. Examples of the polymer having at least one selected from the group consisting of a carboxy group and a carboxylate group include ammonium polyacrylate, a polyacrylic acid, a copolymer of an acrylic acid and alkyl acrylate, a copolymer of an acrylic acid and a methacrylic acid, and salts thereof. From the viewpoint of easily obtaining a high polishing rate for silicon oxide of a convex portion of a pattern wafer, the viewpoint of easily achieving a high polishing rate ratio of silicon oxide of a convex portion of a pattern wafer with respect to silicon oxide of a blanket wafer, and the viewpoint of easily suppressing the polishing rate for silicon nitride, the polishing liquid of the present embodiment may contain, as the anionic dispersant in contact with the abrasive grains, at least one selected from the group consisting of a polymer having at least one selected from the group consisting of a carboxy group and a carboxylate group, and ammonium dihydrogen phosphate.

The average particle diameter of the abrasive grains may be 50 nm or more, 70 nm or more, 80 nm or more, 100 nm or more, more than 100 nm, 105 nm or more, 110 nm or more, 115 nm or more, 120 nm or more, 125 nm or more, 130 nm or more, 135 nm or more, or 140 nm or more, from the viewpoint of easily obtaining a high polishing rate for silicon oxide of a convex portion of a pattern wafer and the viewpoint of easily achieving high-rate polishing of silicon oxide of a blanket wafer having no concavo-convex pattern. The average particle diameter of the abrasive grains may be 500 nm or less, 400 nm or less, 300 nm or less, 200 nm or less, 180 nm or less, 150 nm or less, or 140 nm or less, from the viewpoint of easily suppressing the occurrence of polishing scratches. From these viewpoints, the average particle diameter of the abrasive grains may be 50 to 500 nm, 50 to 200 nm, 50 to 150 nm, 70 to 500 nm, 70 to 200 nm, 70 to 150 nm, 100 to 500 nm, 100 to 200 nm, or 100 to 150 nm.

The “average particle diameter of the abrasive grains” means median of the volume distribution measured for an abrasive grain-dispersed sample using a particle size distribution measuring device (for example, a laser diffraction/scattering particle size distribution measuring device), and can be measured using trade name: Microtrac MT3300EXII manufactured by MicrotracBEL Corp., or the like. For example, a sample is prepared by dispersing abrasive grains in water so that the content of the abrasive grains is adjusted to the content having a scattering intensity in a range suitable for measurement, this sample is set in the measuring device, and then the average particle diameter is measured. In the case of measuring the particle diameter of the abrasive grains in the polishing liquid, a sample is prepared by adjusting the content of the abrasive grains in the polishing liquid so that the content of the abrasive grains having a scattering intensity in a range suitable for measurement is obtained, and the measurement can be performed using this sample by the same method. By adjusting the average particle diameter of the abrasive grains, a high polishing rate for silicon oxide and low scratch characteristics according to the particle diameter of the abrasive grains are efficiently obtained.

The content of the abrasive grains may be in the following range on the basis of the total mass of the polishing liquid, from the viewpoint of achieving an excellent balance between the polishing rate for silicon oxide of a convex portion of a pattern wafer and the dispersion stability of the abrasive grains. The content of the abrasive grains may be 0.01% by mass or more, 0.05% by mass or more, 0.1% by mass or more, 0.2% by mass or more, 0.3% by mass or more, 0.4% by mass or more, 0.5% by mass or more, 0.6% by mass or more, 0.8% by mass or more, 1% by mass or more, 1.2% by mass or more, 1.5% by mass or more, 1.8% by mass or more, or 2% by mass or more. The content of the abrasive grains may be 10% by mass or less, 5% by mass or less, 3% by mass or less, 2.5% by mass or less, 2% by mass or less, 1.8% by mass or less, 1.5% by mass or less, 1.2% by mass or less, 1% by mass or less, 0.8% by mass or less, 0.6% by mass or less, or 0.5% by mass or less. From these viewpoints, the content of the abrasive grains may be 0.01 to 10% by mass, 0.01 to 3% by mass, 0.01 to 1% by mass, 0.05 to 10% by mass, 0.05 to 3% by mass, 0.05 to 1% by mass, 0.1 to 10% by mass, 0.1 to 3% by mass, 0.1 to 1% by mass, 0.8 to 10% by mass, or 0.8 to 3% by mass.

### (Additive)

### [Component (A1): 4-Pyrone-Based Compound]

The additive of the polishing liquid of the first embodiment includes a 4-pyrone-based compound represented by General Formula (1) (hereinafter, simply referred to as “4-pyrone-based compound” in some cases) as the component (A1). It is presumed that the use of the 4-pyrone-based compound increases the interaction between the polishing liquid and silicon oxide, so that the polishing rate is likely to increase.

The 4-pyrone-based compound is a compound represented by General Formula (1) below, and is a compound having a structure in which a hydroxy group is bonded to a carbon atom adjacent to a carbon atom of a carbonyl group. The “4-pyrone-based compound” is a heterocyclic compound having a γ-pyrone ring (6-membered ring) which has an oxy group and a carbonyl group and in which the carbonyl group is located at the 4th position with respect to the oxy group. In the 4-pyrone-based compound, the hydroxy group is bonded to the carbon atom adjacent to the carboxy group in this γ-pyrone ring, and other carbon atoms may be substituted with substituents other than hydrogen atoms.

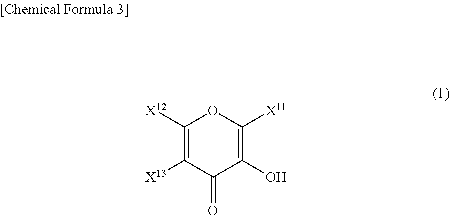

In the formula, X¹¹, X¹², and X¹³ are each independently a hydrogen atom or a monovalent substituent. Examples of the monovalent substituent include an aldehyde group, a hydroxy group, a carboxy group, a carboxylate group, a sulfonic acid group, a phosphoric acid group, a bromine atom, a chlorine atom, an iodine atom, a fluorine atom, a nitro group, a hydrazine group, an alkyl group (for example, an alkyl group having 1 to 8 carbon atoms), an aryl group (for example, an aryl group having 6 to 12 carbon atoms), and an alkenyl group (for example, an alkenyl group having 1 to 8 carbon atoms). The alkyl group, the aryl group, and the alkenyl group may be substituted with OH, COOH, Br, Cl, I, NO₂, or the like. In the case of having a monovalent substituent as X¹¹, X¹², and X¹³, the substituent may be bonded to a carbon atom adjacent to an oxy group, that is, X¹¹ and X¹² may be substituents. At least two of X¹¹, X¹², and X¹³ may be a hydrogen atom.

From the viewpoint of easily obtaining a high polishing rate for silicon oxide of a convex portion of a pattern wafer, the viewpoint of easily achieving a high polishing rate ratio of silicon oxide of a convex portion of a pattern wafer with respect to silicon oxide of a blanket wafer, and the viewpoint of easily achieving excellent dispersion stability of the abrasive grains, the 4-pyrone-based compound may include at least one selected from the group consisting of 3-hydroxy-2-methyl-4-pyrone (also known as: 3-hydroxy-2-methyl-4H-pyran-4-one, maltol), 5-hydroxy-2-(hydroxymethyl)-4-pyrone (also known as: 5-hydroxy-2-(hydroxymethyl)-4H-pyran-4-one, kojic acid), and 2-ethyl-3-hydroxy-4-pyrone (also known as: 2-ethyl-3-hydroxy-4H-pyran-4-one), may include at least one selected from the group consisting of 3-hydroxy-2-methyl-4-pyrone and 5-hydroxy-2-(hydroxymethyl)-4-pyrone, and may include 3-hydroxy-2-methyl-4-pyrone. The 4-pyrone-based compound can be used singly or in combination of two or more types thereof.

The 4-pyrone-based compound may be water-soluble. By using a compound having a high degree of solubility in water, a desired amount of the additive can be well dissolved in the polishing liquid, and the effects of improving a polishing rate and the dispersion stability of the abrasive grains can be achieved at an even higher level. The degree of solubility of the 4-pyrone-based compound with respect to 100 g of water at room temperature (25° C.) may be 0.001 g or more, 0.005 g or more, 0.01 g or more, or 0.05 g or more. The upper limit of the degree of solubility is not particularly limited.

The content of the 4-pyrone-based compound may be in the following range on the basis of the total mass of the polishing liquid from the viewpoint of easily obtaining a high polishing rate for silicon oxide of a convex portion of a pattern wafer, the viewpoint of easily achieving a high polishing rate ratio of silicon oxide of a convex portion of a pattern wafer with respect to silicon oxide of a blanket wafer, and the viewpoint of easily suppressing the polishing rate for silicon nitride. The content of the 4-pyrone-based compound may be 0.001% by mass or more, 0.003% by mass or more, 0.005% by mass or more, 0.008% by mass or more, 0.01% by mass or more, 0.02% by mass or more, 0.03% by mass or more, 0.04% by mass or more, 0.05% by mass or more, 0.06% by mass or more, 0.08% by mass or more, 0.10% by mass or more, 0.12% by mass or more, 0.15% by mass or more, 0.18% by mass or more, or 0.2% by mass or more. The content of the 4-pyrone-based compound may be 5% by mass or less, 3% by mass or less, 1% by mass or less, 0.8% by mass or less, 0.5% by mass or less, 0.3% by mass or less, 0.2% by mass or less, 0.18% by mass or less, 0.15% by mass or less, 0.12% by mass or less, 0.1% by mass or less, 0.08% by mass or less, 0.06% by mass or less, 0.05% by mass or less, 0.04% by mass or less, 0.03% by mass or less, 0.02% by mass or less, 0.01% by mass or less, less than 0.01% by mass, 0.008% by mass or less, or 0.005% by mass or less. From these viewpoints, the content of the 4-pyrone-based compound may be 0.001 to 5% by mass, 0.001 to 1% by mass, 0.001 to 0.3% by mass, 0.001 to 0.1% by mass, 0.001 to 0.05% by mass, 0.01 to 5% by mass, 0.01 to 1% by mass, 0.01 to 0.3% by mass, 0.01 to 0.1% by mass, 0.01 to 0.05% by mass, 0.02 to 5% by mass, 0.02 to 1% by mass, 0.02 to 0.3% by mass, 0.02 to 0.1% by mass, or 0.02 to 0.05% by mass.

A mass ratio A1 of the content of the 4-pyrone-based compound with respect to the content of the abrasive grains (4-pyrone-based compound/abrasive grains) may be in the following range from the viewpoint of easily obtaining a high polishing rate for silicon oxide of a convex portion of a pattern wafer, the viewpoint of easily achieving a high polishing rate ratio of silicon oxide of a convex portion of a pattern wafer with respect to silicon oxide of a blanket wafer, and the viewpoint of easily suppressing the polishing rate for silicon nitride. The mass ratio A1 may be 0.001 or more, 0.002 or more, 0.003 or more, 0.005 or more, 0.008 or more, 0.01 or more, 0.02 or more, 0.025 or more, 0.03 or more, 0.05 or more, 0.08 or more, 0.1 or more, 0.12 or more, 0.15 or more, 0.18 or more, 0.2 or more, 0.25 or more, 0.3 or more, 0.35 or more, or 0.4 or more. The mass ratio A1 may be 1 or less, less than 1, 0.8 or less, 0.6 or less, 0.5 or less, 0.4 or less, 0.35 or less, 0.3 or less, 0.25 or less, 0.2 or less, 0.18 or less, 0.15 or less, 0.12 or less, 0.1 or less, 0.08 or less, 0.05 or less, 0.03 or less, 0.025 or less, 0.02 or less, 0.01 or less, 0.008 or less, 0.005 or less, or 0.003 or less. From these viewpoints, the mass ratio A1 may be 0.001 to 1, 0.001 to 0.5, 0.001 to 0.2, 0.001 to 0.1, 0.01 to 1, 0.01 to 0.5, 0.01 to 0.2, 0.01 to 0.1, 0.1 to 1, 0.1 to 0.5, or 0.1 to 0.2.

### [Component (A2): Picolinic Acid Compound]

The additive of the polishing liquid of the second embodiment includes a picolinic acid compound as the component (A2). It is presumed that the use of the component (A2) increases the interaction between the polishing liquid and silicon oxide, so that the polishing rate is likely to increase.

As the picolinic acid compound, at least one selected from the group consisting of picolinic acid (a compound having a pyridine ring ad a carboxy group bonded at the 2-position of the pyridine ring) and a picolinic acid derivative can be used. The picolinic acid derivative may be a compound having a pyridine ring, a carboxy group bonded at the 2-position of the pyridine ring, and a substituent bonded at a position other than the 2-position of the pyridine ring, and may be a compound having a pyridine ring and a carboxylate group bonded at the 2-position of the pyridine ring (this compound may have a substituent bonded at a position other than the 2-position of the pyridine ring). As the picolinic acid derivative, a picolinate (a compound having a pyridine ring and a carboxylate group bonded at the 2-position of the pyridine ring) may be used, and a compound having a pyridine ring, a carboxy group or carboxylate group bonded at the 2-position of the pyridine ring, and a substituent bonded at a position other than the 2-position of the pyridine ring may be used. Examples of the carboxylate group include a functional group in which a hydrogen atom of a carboxy group is substituted with a metal atom (such as a sodium atom or a potassium atom). Examples of the substituent bonded at a position other than the 2-position of the pyridine ring include a hydroxy group, an amino group, an alkyl group, and a vinyl group.

From the viewpoint of easily obtaining a high polishing rate for silicon oxide of a convex portion of a pattern wafer, the viewpoint of easily achieving a high polishing rate ratio of silicon oxide of a convex portion of a pattern wafer with respect to silicon oxide of a blanket wafer, and the viewpoint of easily suppressing the polishing rate for silicon nitride, the picolinic acid compound may include at least one selected from the group consisting of picolinic acid, hydroxypicolinic acid, aminopicolinic acid, and salts thereof, and may include at least one selected from the group consisting of picolinic acid, 3-hydroxypicolinic acid, 3-aminopicolinic acid, 5-hydroxypicolinic acid, 5-aminopicolinic acid, and salts thereof. The picolinic acid compound may be an embodiment including at least one selected from the group consisting of picolinic acid and a salt thereof, an embodiment including picolinic acid, an embodiment including at least one selected from the group consisting of hydroxypicolinic acid and a salt thereof, an embodiment including hydroxypicolinic acid, an embodiment including at least one selected from the group consisting of aminopicolinic acid and a salt thereof, or an embodiment including aminopicolinic aminopicolinic acid.

As the content of the picolinic acid compound, the content of the picolinic acid, the content of the hydroxypicolinic acid, or the content of the aminopicolinic acid, a content A may be in the following range on the basis of the total mass of the polishing liquid from the viewpoint of easily obtaining a high polishing rate for silicon oxide of a convex portion of a pattern wafer, the viewpoint of easily achieving a high polishing rate ratio of silicon oxide of a convex portion of a pattern wafer with respect to silicon oxide of a blanket wafer, and the viewpoint of easily suppressing the polishing rate for silicon nitride. The content A may be 0.0001% by mass or more, 0.0005% by mass or more, 0.001% by mass or more, 0.003% by mass or more, 0.005% by mass or more, 0.008% by mass or more, 0.01% by mass or more, 0.02% by mass or more, 0.03% by mass or more, 0.04% by mass or more, 0.05% by mass or more, 0.055% by mass or more, 0.06% by mass or more, 0.07% by mass or more, 0.08% by mass or more, 0.09% by mass or more, or 0.1% by mass or more. The content A may be 5% by mass or less, 3% by mass or less, 1% by mass or less, 0.8% by mass or less, 0.5% by mass or less, 0.4% by mass or less, 0.3% by mass or less, 0.2% by mass or less, 0.1% by mass or less, 0.09% by mass or less, 0.08% by mass or less, 0.07% by mass or less, 0.06% by mass or less, 0.055% by mass or less, 0.05% by mass or less, 0.04% by mass or less, 0.03% by mass or less, 0.02% by mass or less, 0.010% by mass or less, less than 0.010% by mass, 0.008% by mass or less, or 0.005% by mass or less. From these viewpoints, the content A may be 0.0001 to 5% by mass, 0.0001 to 1% by mass, 0.0001 to 0.3% by mass, 0.0001 to 0.08% by mass, 0.001 to 5% by mass, 0.001 to 1% by mass, 0.001 to 0.3% by mass, 0.001 to 0.08% by mass, 0.01 to 5% by mass, 0.01 to 1% by mass, 0.01 to 0.3% by mass, 0.01 to 0.08% by mass, 0.05 to 5% by mass, 0.05 to 1% by mass, 0.05 to 0.3% by mass, or 0.05 to 0.08% by mass.

As the mass ratio of the content of the picolinic acid compound with respect to the content of the abrasive grains (picolinic acid compound/abrasive grains), the mass ratio of the content of the picolinic acid with respect to the content of the abrasive grains (picolinic acid/abrasive grains), the mass ratio of the content of the hydroxypicolinic acid with respect to the content of the abrasive grains (hydroxypicolinic acid/abrasive grains), or the mass ratio of the content of the aminopicolinic acid with respect to the content of the abrasive grains (aminopicolinic acid/abrasive grains), a mass ratio A2 may be in the following range from the viewpoint of easily obtaining a high polishing rate for silicon oxide of a convex portion of a pattern wafer, the viewpoint of easily achieving a high polishing rate ratio of silicon oxide of a convex portion of a pattern wafer with respect to silicon oxide of a blanket wafer, and the viewpoint of easily suppressing the polishing rate for silicon nitride. The mass ratio A2 may be 0.001 or more, 0.002 or more, 0.003 or more, 0.005 or more, 0.008 or more, 0.01 or more, 0.02 or more, 0.025 or more, 0.0275 or more, 0.03 or more, 0.04 or more, 0.05 or more, 0.08 or more, or 0.1 or more. The mass ratio A2 may be 1 or less, less than 1, 0.8 or less, 0.6 or less, 0.5 or less, 0.4 or less, 0.3 or less, 0.2 or less, 0.1 or less, 0.08 or less, 0.05 or less, 0.04 or less, 0.03 or less, 0.0275 or less, 0.025 or less, 0.02 or less, 0.01 or less, 0.008 or less, 0.005 or less, or 0.003 or less. From these viewpoints, the mass ratio A2 may be 0.001 to 1, 0.001 to 0.3, 0.001 to 0.1, 0.001 to 0.03, 0.003 to 1, 0.003 to 0.3, 0.003 to 0.1, 0.003 to 0.03, 0.01 to 1, 0.01 to 0.3, 0.01 to 0.1, or 0.01 to 0.03.

### [Component (B): Nitrogen-Containing Hydroxyalkyl Compound]

The additive of the polishing liquid of the present embodiment may include a compound having two or more nitrogen atoms to which a hydroxyalkyl group is bonded (nitrogen-containing hydroxyalkyl compound; note that the compound corresponding to the component (A1) is excluded) as the component (B). By using the component (B), a high polishing rate for silicon oxide of a convex portion is easily obtained by increasing the interaction between the polishing liquid and silicon oxide of a convex portion in a concavo-convex pattern, and the polishing rate for silicon nitride that can be used as a stopper material is easily suppressed. In the component (B), the hydroxyalkyl group is directly bonded to the nitrogen atom, and the hydroxy group is directly bonded to the alkyl group directly bonded to the nitrogen atom. In the component (B), an alkyl group having no substituent other than a hydroxy group can be used as the hydroxyalkyl group bonded to the nitrogen atom.

From the viewpoint of easily obtaining a high polishing rate for silicon oxide of a convex portion of a pattern wafer, the viewpoint of easily achieving high-rate polishing of silicon oxide of a blanket wafer, and the viewpoint of easily suppressing the polishing rate for silicon nitride, the component (B) may include a compound having a nitrogen atom to which two hydroxyalkyl groups are bonded, and may include a compound having two or more nitrogen atoms to which two hydroxyalkyl groups are bonded.

The number of nitrogen atoms in one molecule in the component (B) may be 2 to 5, 2 to 4, or 2 to 3, from the viewpoint of easily obtaining a high polishing rate for silicon oxide of a convex portion of a pattern wafer, the viewpoint of easily achieving high-rate polishing of silicon oxide of a blanket wafer, and the viewpoint of easily suppressing the polishing rate for silicon nitride. The number of hydroxy groups in one molecule in the component (B) may be 2 to 6, 2 to 5, 2 to 4, 3 to 6, 3 to 5, 3 to 4, 4 to 6, or 4 to 5, from the viewpoint of easily obtaining a high polishing rate for silicon oxide of a convex portion of a pattern wafer, the viewpoint of easily achieving high-rate polishing of silicon oxide of a blanket wafer, and the viewpoint of easily suppressing the polishing rate for silicon nitride.

From the viewpoint of easily obtaining a high polishing rate for silicon oxide of a convex portion of a pattern wafer, the viewpoint of easily achieving high-rate polishing of silicon oxide of a blanket wafer, and the viewpoint of easily suppressing the polishing rate for silicon nitride, the component (B) may have a hydroxyalkyl group having the number of carbon atoms of 1 to 4, 2 to 4, 3 to 4, 1 to 3, 2 to 3, or 1 to 2 as the hydroxyalkyl group bonded to the nitrogen atom. From the viewpoint of easily obtaining a high polishing rate for silicon oxide of a convex portion of a pattern wafer, the viewpoint of easily achieving high-rate polishing of silicon oxide of a blanket wafer, and the viewpoint of easily suppressing the polishing rate for silicon nitride, the component (B) may have a hydroxyalkyl group having the number of hydroxy groups of 1 to 3 or 1 to 2 as the hydroxyalkyl group bonded to the nitrogen atom.

From the viewpoint of easily obtaining a high polishing rate for silicon oxide of a convex portion of a pattern wafer, the viewpoint of easily achieving high-rate polishing of silicon oxide of a blanket wafer, and the viewpoint of easily suppressing the polishing rate for silicon nitride, the component (B) may have an alkylene group between two nitrogen atoms to which a hydroxyalkyl group is bonded, and the number of carbon atoms of the alkylene group may be 1 to 4, 2 to 4, 1 to 3, 2 to 3, or 1 to 2.

From the viewpoint of easily obtaining a high polishing rate for silicon oxide of a convex portion of a pattern wafer, the viewpoint of easily achieving high-rate polishing of silicon oxide of a blanket wafer, and the viewpoint of easily suppressing the polishing rate for silicon nitride, the component (B) may include a compound represented by General formula (I) below.

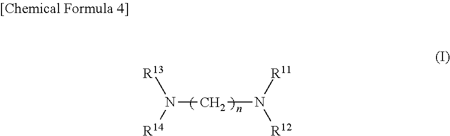

[In the formula, n is an integer of 1 or more, R¹¹, R¹², R¹³, and R¹⁴ each independently represent a hydrogen atom or an organic group, one or both of R¹¹ and R¹² are a hydroxyalkyl group, and one or both of R¹³ and R¹⁴ are a hydroxyalkyl group.]

n may be in the aforementioned range for the number of carbon atoms of the alkylene group between two nitrogen atoms to which the hydroxyalkyl group is bonded. The organic group may be a substituted or unsubstituted alkyl group, may be a hydroxyalkyl group, and may be a group having a nitrogen atom to which a hydroxyalkyl group is bonded. Examples of the substituent of the alkyl group include a hydroxy group, a carboxy group, an amino group, a sulfo group, and a nitro group. In a case where R¹¹, R¹², R¹³, or R¹⁴ is a hydroxyalkyl group, the number of carbon atoms of the hydroxyalkyl group may be in the aforementioned range for the number of carbon atoms of the hydroxyalkyl group bonded to the nitrogen atom.

Examples of the component (B) include an ethylenedinitrilotetraethanol (THEED: 2,2′,2″,2′″-ethylenedinitrilotetraethanol (also known as: N,N,N′,N′-Tetrakis(2-hydroxyethyl)ethylenediamine) and the like), an ethylenedinitrilotetrapropanol (EDTP: 1,1′,1″,1′″-ethylenedinitrilotetra-2-propanol (also known as: N,N,N′,N′-Tetrakis(2-hydroxypropyl)ethylenediamine) and the like), and N,N,N′,N″,N″-pentakis(2-hydroxypropyl)diethylenetriamine. From the viewpoint of easily obtaining a high polishing rate for silicon oxide of a convex portion of a pattern wafer, the viewpoint of easily achieving high-rate polishing of silicon oxide of a blanket wafer, and the viewpoint of easily suppressing the polishing rate for silicon nitride, the component (B) may include at least one selected from the group consisting of an ethylenedinitrilotetraethanol and an ethylenedinitrilotetrapropanol, and may include an ethylenedinitrilotetraethanol. From the viewpoint of easily obtaining a high polishing rate for silicon oxide of a convex portion of a pattern wafer, the viewpoint of easily achieving high-rate polishing of silicon oxide of a blanket wafer, and the viewpoint of easily suppressing the polishing rate for silicon nitride, the component (B) may include a compound not having a carboxy group.

From the viewpoint of easily obtaining a high polishing rate for silicon oxide of a convex portion of a pattern wafer, the viewpoint of easily achieving high-rate polishing of silicon oxide of a blanket wafer, and the viewpoint of easily suppressing the polishing rate for silicon nitride, the molecular weight of the component (B) may be in the following range. The molecular weight of the component (B) may be 50 or more, 60 or more, 80 or more, 100 or more, 120 or more, 140 or more, 150 or more, 160 or more, 180 or more, 200 or more, 220 or more, or 230 or more. The molecular weight of the component (B) may be 1000 or less, less than 1000, 900 or less, 800 or less, 700 or less, 600 or less, 500 or less, 400 or less, 350 or less, 300 or less, 280 or less, 250 or less, less than 250, or 240 or less. From these viewpoints, the molecular weight of the component (B) may be 50 to 1000, 50 to 500, 50 to 300, 50 to 250, 100 to 1000, 100 to 500, 100 to 300, 100 to 250, 200 to 1000, 200 to 500, 200 to 300, or 200 to 250.

In the polishing liquid of the first embodiment, as the content of the component (B) or the content of the ethylenedinitrilotetraethanol, a content B1 may be in the following range on the basis of the total mass of the polishing liquid from the viewpoint of easily obtaining a high polishing rate for silicon oxide of a convex portion of a pattern wafer, the viewpoint of easily achieving high-rate polishing of silicon oxide of a blanket wafer, and the viewpoint of easily suppressing the polishing rate for silicon nitride. The content B1 may be 0.001% by mass or more, 0.003% by mass or more, 0.005% by mass or more, 0.008% by mass or more, or 0.009% by mass or more. The content B1 may be 5% by mass or less, 3% by mass or less, 1% by mass or less, 0.5% by mass or less, 0.1% by mass or less, 0.05% by mass or less, 0.03% by mass or less, 0.01% by mass or less, or 0.009% by mass or less. From these viewpoints, the content B1 may be 0.001 to 5% by mass, 0.001 to 1% by mass, 0.001 to 0.1% by mass, 0.001 to 0.01% by mass, 0.003 to 5% by mass, 0.003 to 1% by mass, 0.003 to 0.1% by mass, 0.003 to 0.01% by mass, 0.005 to 5% by mass, 0.005 to 10% by mass, 0.005 to 0.10% by mass, or 0.005 to 0.01% by mass.

In the polishing liquid of the second embodiment, as the content of the component (B) or the content of the ethylenedinitrilotetraethanol, a content B2 may be in the following range on the basis of the total mass of the polishing liquid from the viewpoint of easily obtaining a high polishing rate for silicon oxide of a convex portion of a pattern wafer, the viewpoint of easily achieving high-rate polishing of silicon oxide of a blanket wafer, and the viewpoint of easily suppressing the polishing rate for silicon nitride. The content B2 may be 0.001% by mass or more, 0.005% by mass or more, 0.01% by mass or more, 0.015% by mass or more, 0.02% by mass or more, 0.025% by mass or more, 0.03% by mass or more, 0.035% by mass or more, 0.04% by mass or more, 0.045% by mass or more, 0.05% by mass or more, 0.055% by mass or more, 0.06% by mass or more, 0.065% by mass or more, 0.07% by mass or more, or 0.075% by mass or more. The content B2 may be 5% by mass or less, 3% by mass or less, 1% by mass or less, 0.5% by mass or less, 0.4% by mass or less, 0.3% by mass or less, 0.2% by mass or less, 0.1% by mass or less, 0.09% by mass or less, 0.085% by mass or less, 0.08% by mass or less, 0.075% by mass or less, 0.07% by mass or less, 0.065% by mass or less, or 0.06% by mass or less. From these viewpoints, the content B2 may be 0.001 to 5% by mass, 0.001 to 1% by mass, 0.001 to 0.1% by mass, 0.01 to 5% by mass, 0.01 to 1% by mass, 0.01 to 0.1% by mass, 0.05 to 5% by mass, 0.05 to 1% by mass, or 0.05 to 0.10% by mass.

In the polishing liquid of the first embodiment, as the mass ratio of the content of the component (B) with respect to the content of the abrasive grains (component (B)/abrasive grains), or the mass ratio of the content of the ethylenedinitrilotetraethanol with respect to the content of the abrasive grains (ethylenedinitrilotetraethanol/abrasive grains), a mass ratio B11 may be in the following range from the viewpoint of easily obtaining a high polishing rate for silicon oxide of a convex portion of a pattern wafer, the viewpoint of easily achieving high-rate polishing of silicon oxide of a blanket wafer, and the viewpoint of easily suppressing the polishing rate for silicon nitride. The mass ratio B11 may be 0.0001 or more, 0.0005 or more, 0.001 or more, 0.002 or more, 0.003 or more, 0.004 or more, or 0.0045 or more. The mass ratio B11 may be 1 or less, 0.8 or less, 0.5 or less, 0.3 or less, 0.1 or less, 0.08 or less, 0.05 or less, 0.03 or less, 0.01 or less, 0.008 or less, 0.005 or less, or 0.0045 or less. From these viewpoints, the mass ratio B11 may be 0.0001 to 1, 0.0001 to 0.1, 0.0001 to 0.01, 0.001 to 1, 0.001 to 0.1, 0.001 to 0.01, 0.003 to 1, 0.003 to 0.1, or 0.003 to 0.01.

In the polishing liquid of the second embodiment, as the mass ratio of the content of the component (B) with respect to the content of the abrasive grains (component (B)/abrasive grains), or the mass ratio of the content of the ethylenedinitrilotetraethanol with respect to the content of the abrasive grains (ethylenedinitrilotetraethanol/abrasive grains), a mass ratio B21 may be in the following range from the viewpoint of easily obtaining a high polishing rate for silicon oxide of a convex portion of a pattern wafer, the viewpoint of easily achieving high-rate polishing of silicon oxide of a blanket wafer, and the viewpoint of easily suppressing the polishing rate for silicon nitride. The mass ratio B21 may be 0.001 or more, 0.005 or more, 0.01 or more, 0.015 or more, 0.02 or more, 0.025 or more, 0.03 or more, or 0.035 or more. The mass ratio B21 may be 1 or less, 0.5 or less, 0.3 or less, 0.1 or less, 0.08 or less, 0.05 or less, 0.045 or less, 0.04 or less, 0.035 or less, or 0.03 or less. From these viewpoints, the mass ratio B21 may be 0.001 to 1, 0.001 to 0.1, 0.001 to 0.05, 0.01 to 1, 0.01 to 0.1, 0.01 to 0.05, 0.03 to 1, 0.03 to 0.1, or 0.03 to 0.05.

In the polishing liquid of the first embodiment, as the mass ratio of the content of the component (B) with respect to the content of the component (A1) (component (B)/component (A1)), or the mass ratio of the content of the ethylenedinitrilotetraethanol with respect to the content of the component (A1) (ethylenedinitrilotetraethanol/component (A1)), a mass ratio B12 may be in the following range from the viewpoint of easily obtaining a high polishing rate for silicon oxide of a convex portion of a pattern wafer, the viewpoint of easily achieving high-rate polishing of silicon oxide of a blanket wafer, and the viewpoint of easily suppressing the polishing rate for silicon nitride. The mass ratio B12 may be 0.01 or more, 0.05 or more, 0.1 or more, 0.3 or more, 0.5 or more, 0.7 or more, 0.8 or more, or 0.9 or more. The mass ratio B12 may be 10 or less, 8 or less, 5 or less, 4 or less, 3 or less, 2.5 or less, 2 or less, 1.5 or less, 1 or less, less than 1, or 0.9 or less. From these viewpoints, the mass ratio B12 may be 0.01 to 10, 0.01 to 5, 0.01 to 1, 0.1 to 10, 0.1 to 5, 0.1 to 1, 0.5 to 10, 0.5 to 5, or 0.5 to 1.

In the polishing liquid of the second embodiment, as the mass ratio of the content of the component (B) with respect to the content of the component (A2) (component (B)/component (A2)), or the mass ratio of the content of the ethylenedinitrilotetraethanol with respect to the content of the component (A2) (ethylenedinitrilotetraethanol/component (A2)), a mass ratio B22 may be in the following range from the viewpoint of easily obtaining a high polishing rate for silicon oxide of a convex portion of a pattern wafer, the viewpoint of easily achieving high-rate polishing of silicon oxide of a blanket wafer, and the viewpoint of easily suppressing the polishing rate for silicon nitride. The mass ratio B22 may be 0.01 or more, 0.05 or more, 0.1 or more, 0.2 or more, 0.3 or more, 0.4 or more, 0.5 or more, 0.6 or more, 0.7 or more, 0.75 or more, 0.8 or more, 0.9 or more, 1 or more, more than 1, 1.1 or more, or 1.2 or more. The mass ratio B22 may be 10 or less, 8 or less, 5 or less, 4 or less, 3 or less, 2.5 or less, 2 or less, 1.5 or less, 1.2 or less, 1.1 or less, 1 or less, less than 1, 0.9 or less, or 0.8 or less. From these viewpoints, the mass ratio B22 may be 0.01 to 10, 0.01 to 5, 0.01 to 2, 0.1 to 10, 0.1 to 5, 0.1 to 2, 0.5 to 10, 0.5 to 5, or 0.5 to 2.

### [Other Additive]

The additive of the polishing liquid of the present embodiment may further include other component (component not corresponding to each component mentioned above) according to desired characteristics. Examples of such a component include a nonionic polymer; a cationic compound; a pH adjusting agent described below; a polar solvent such as ethanol and acetone; and a cyclic monocarboxylic acid.

The polishing liquid of the present embodiment may contain a compound a having a molecular weight of 100000 or less and having four or more hydroxy groups, or may not contain the compound a. The content of the compound a may be 0.01% by mass or less, less than 0.010% by mass, 0.001% by mass or less, 0.0001% by mass or less, or substantially 0% by mass, on the basis of the total mass of the polishing liquid. The polishing liquid of the present embodiment may contain a compound b having four or more amino groups, or may not contain the compound b. The content of the compound b may be 0.001% by mass or less, less than 0.001% by mass, 0.0001% by mass or less, 0.00001% by mass or less, or substantially 0% by mass, on the basis of the total mass of the polishing liquid. The mass ratio of the content of the compound a with respect to the content of the compound b (compound a/compound b) may be 0.10 or less or less than 0.10.

### (Water)

Water is not particularly limited, and may include at least one selected from the group consisting of deionized water, ion-exchange water, and ultrapure water.

(pH)

The pH of the polishing liquid of the present embodiment is 5.0 or more from the viewpoint of achieving excellent dispersion stability of the abrasive grains. When the pH is 5.0 or more in a case where the zeta potential of the abrasive grains is adjusted to be negative by using the anionic dispersant, the anionic dispersant is sufficiently dissociated and the zeta potential of the abrasive grains is likely to be maintained negative. From the viewpoint of easily achieving excellent dispersion stability of the abrasive grains, the viewpoint of easily obtaining a high polishing rate for silicon oxide of a convex portion of a pattern wafer, the viewpoint of easily achieving high-rate polishing of silicon oxide of a blanket wafer, and the viewpoint of easily suppressing the polishing rate for silicon nitride, the pH may be in the following range. The pH may be 12.0 or less, 11.0 or less, 10.5 or less, less than 10.5, 10.0 or less, less than 10.0, 9.5 or less, 9.0 or less, less than 9.0, 8.8 or less, 8.5 or less, 8.2 or less, 8.0 or less, less than 8.0, 7.8 or less, 7.5 or less, 7.2 or less, 7.0 or less, less than 7.0, 6.8 or less, 6.7 or less, 6.5 or less, 6.2 or less, 6.0 or less, less than 6.0, 5.7 or less, 5.5 or less, or 5.4 or less. The pH may be more than 5.0, 5.2 or more, 5.4 or more, 5.5 or more, more than 5.5, 5.7 or more, 6.0 or more, more than 6.0, 6.2 or more, 6.5 or more, 6.7 or more, 6.8 or more, 7.0 or more, more than 7.0, 7.2 or more, 7.5 or more, 7.8 or more, 8.0 or more, more than 8.0, or 8.2 or more. From these viewpoints, the pH may be 5.0 to 12.0, 5.0 to 9.0, 5.0 to 7.5, 6.0 to 12.0, 6.0 to 9.0, 6.0 to 7.5, 6.5 to 12.0, 6.5 to 9.0, or 6.5 to 7.5. The pH can be measured by a method described in Examples.

Since the pH can vary depending on the type of a compound used as an additive, a pH adjusting agent may be used for adjusting the pH in the above range. The pH adjusting agent is not particularly limited, and examples thereof include acids such as nitric acid, sulfuric acid, hydrochloric acid, phosphoric acid, and boric acid; and bases such as sodium hydroxide, ammonia (for example, ammonia water), potassium hydroxide, and calcium hydroxide. The aforementioned additive such as the component (A1), the component (A2), or the component (B) may be used for pH adjustment. From the viewpoint of improving the productivity, a polishing liquid is prepared without using a pH adjusting agent, and this polishing liquid may be applied directly to CMP.

### <Preparation Method and Usage Method of Polishing Liquid>

The polishing liquid of the present embodiment can be categorized as (a) a normal type, (b) a concentrated type, and (c) a multiple-liquid type (for example, two-liquid type; polishing liquid set for CMP), and the preparation methods and the usage methods differ depending on the type. The (a) normal type is a polishing liquid that can be used directly without pretreatment such as dilution at the time of polishing. The (b) concentrated type is a polishing liquid in which the components are more concentrated than in the (a) normal type, taking into consideration the convenience of storage or transportation. The (c) multiple-liquid type is a polishing liquid that, during storage or transportation, is kept as a state where the components are separated into multiple liquids (for example, a state of being separated into a first liquid containing certain components and a second liquid containing other components), the liquids being mixed and used at the time of use.

The (a) normal type can be obtained by dissolving or dispersing the abrasive grains and the additive in water as a main dispersion medium. The polishing liquid can be prepared using, for example, a stirrer, a homogenizer, an ultrasonic dispersing machine, a wet ball mill, or the like. Note that, the abrasive grains may be subjected to a micronization treatment in the process of preparation of the polishing liquid so that the average particle diameter of the abrasive grains is in a desired range. The micronization treatment of the abrasive grains can be performed by a precipitating classification method or a method using a high-pressure homogenizer. The precipitating classification method is a method including a step of forcibly precipitating a slurry containing abrasive grains with a centrifugal separator and a step of removing out only the supernatant solution. Meanwhile, the method using a high-pressure homogenizer is a method in which abrasive grains in a dispersion medium collide with each other at a high pressure.

The (b) concentrated type is diluted with water immediately before use to the desired contents of the components. After dilution, stirring may be performed for any length of time until liquid properties (such as pH and the particle diameter of the abrasive grains) and polishing properties (such as the polishing rate for silicon oxide and the polishing selection ratio of silicon oxide and silicon nitride) equivalent to the (a) normal type are obtained. In the (b) concentrated type as described above, the volume is reduced commensurately with the degree of concentration, and it is thus possible to lower storage and transport costs.

The concentration rate may be 1.5 times or more, 2 times or more, 3 times or more, or 5 times or more. When the concentration rate is 1.5 times or more, there is a tendency that advantages for storage and transport are more easily obtained than in a case where the concentration rate is less than 1.5 times. The concentration rate may be 40 times or less, 20 times or less, or 15 times or less. When the concentration rate is 40 times or less, there is a tendency that the aggregation of the abrasive grains is more easily suppressed than in a case where the concentration rate is more than 40 times.

The (c) multiple-liquid type has the advantage of allowing the aggregation of the abrasive grains to be avoided as compared to the (b) concentrated type by appropriately separating each liquid (such as the first liquid and the second liquid). Here, components to be contained in each liquid are any components. The (c) multiple-liquid type (polishing liquid set for CP) is a polishing liquid set for obtaining a polishing liquid by mixing a first liquid (slurry) and a second liquid (additive liquid). In the (c) multiple-liquid type, the constituent components of the polishing liquid for CP are stored separately in the first liquid and the second liquid, the first liquid contains the abrasive grains and water, and the second liquid contains at least one of the additive, and water. In a first embodiment of the (c) multiple-liquid type, the first liquid contains the abrasive grains and water, and the second liquid contains at least one selected from the group consisting of the component (A1) and the component (A2) and water. In a second embodiment of the (c) multiple-liquid type, the first liquid contains the abrasive grains, one of the component (A1) and the component (A2), and water, and the second liquid contains the other of the component (A1) and the component (A2) and water. The first liquid and the second liquid may contain other components to be blended as necessary. In this case, in order to enhance the dispersibility of the abrasive grains in the first liquid, any acid or alkali may be blended in the first liquid to adjust the pH.

The polishing liquid of the (c) multiple-liquid type is useful in the case of combinations of components that, when mixed, tend to degrade the polishing properties in a relatively short period of time by the aggregation of the abrasive grains, or the like. Note that, from the viewpoint of reducing storage and transportation costs, at least one of respective liquids (such as the first liquid and the second liquid) may be a concentrated type. In this case, when the polishing liquid is used, each liquid and water may be mixed. The concentration rate and the pH of each liquid are any concentration rate and pH, as long as the final mixture may have liquid properties and polishing properties equivalent to those of the polishing liquid of the (a) normal type.

### <Polishing Method>

A polishing method of the present embodiment includes a polishing step of polishing a surface to be polished by using the polishing liquid of the present embodiment. The polishing liquid used in the polishing step may be a polishing liquid obtained by mixing the first liquid and the second liquid of the aforementioned polishing liquid set. That is, the polishing method of the present embodiment may include a polishing step of polishing a surface to be polished by using a polishing liquid obtained by mixing the first liquid and the second liquid of the aforementioned polishing liquid set.

The polishing method of the present embodiment uses a polishing liquid in which the content of each component, the pH, and the like are adjusted and can flatten a base substrate having a silicon oxide film on a surface thereof by the CP technique. The polishing method of the present embodiment is suitable for polishing that requires high-rate, high flatness, and low polishing scratches, such as polishing of the ILD film, and is suitable for polishing many ILD films in a short time. According to an embodiment of the polishing method of the present embodiment, the effect of improving the polishing rate for silicon oxide of a blanket wafer and the effect of improving the in-plane uniformity can be efficiently obtained. According to an embodiment of the polishing method of the present embodiment, since the polishing liquid of the present embodiment is used, the occurrence of polishing scratches can be reduced while achieving excellent dispersion stability of the abrasive grains and achieving a sufficiently high polishing rate.

The polishing step may be a step of supplying the polishing liquid of the present embodiment between a base substrate and a polishing member (a member for polishing; a polishing pad or the like) to polish the base substrate by the polishing member. The polishing method of the present embodiment is suitable for polishing a base substrate having a silicon oxide film on a surface thereof. Therefore, the surface to be polished may contain silicon oxide, and the polishing step may be a step of supplying the polishing liquid of the present embodiment between a silicon oxide film in a base substrate having a silicon oxide film on a surface thereof and a polishing member to polish the silicon oxide film by the polishing member.

The polishing method of the present embodiment may be an embodiment in which a surface to be polished has a concavo-convex pattern configured by a convex portion (Line portion) and a concave portion (Space portion) and the convex portion contains silicon oxide. The width of the convex portion in the concavo-convex pattern may be 30 μm or less or 20 μm or less. The width of the convex portion in the concavo-convex pattern may be 10 μm or more or 20 μm or more. The total of the width of the convex portion and the width of the concave portion in the concavo-convex pattern may be 200 μm or less or 100 μm or less. The total of the width of the convex portion and the width of the concave portion in the concavo-convex pattern may be 80 μm or more or 100 μm or more.

The polishing method of the present embodiment is suitable for polishing a base substrate having a silicon oxide film on the surface thereof in the production process of a device. Examples of the device include a discrete semiconductor such as diode, transistor, compound semiconductor, thermistor, varistor, and thyristor; a memory element such as DRAM (dynamic random access memory), SRAM (static random access memory), EPROM (erasable programmable read-only memory), mask ROM (mask read-only memory), EEPROM (electrically erasable programmable read-only memory), and flash memory; a logic circuit element such as a microprocessor, DSP, and ASIC; an integrated circuit element such as a compound semiconductor typified by MMIC (monolithic microwave integrated circuit); a hybrid integrated circuit (hybrid IC); a light emitting diode; and a photoelectric conversion element such as a charge-coupled element.

According to an embodiment of the polishing liquid of the present embodiment, a high polishing rate can be achieved without greatly depending on the concavo-convex shape of the surface to be polished. Therefore, the polishing method using this polishing liquid can be applied to a base substrate for which it is difficult to achieve a high polishing rate in a method using a conventional polishing liquid.

The polishing method of the present embodiment is suitable for flattening of a surface to be polished having step height (irregularities) on the surface thereof. Examples of the base substrate having such a surface to be polished include logic semiconductor devices. Furthermore, the polishing method of the present embodiment is suitable for polishing a surface including a portion where a concave portion or a convex portion is T-shaped or grid-shaped when viewed from above. For example, the polishing method of the present embodiment can polish a silicon oxide film provided on a surface of a semiconductor device (a DRAM, a flash memory, or the like) having a memory cell at a high rate. It has been difficult to achieve a high polishing rate for these in a method using a conventional polishing liquid for CMP, and it is shown that an embodiment of the polishing liquid of the present embodiment can achieve a high polishing rate without greatly depending on the concavo-convex shape of the surface to be polished.

The base substrate is not limited to a base substrate having only a silicon oxide film on a surface thereof, and may be a base substrate further having a silicon nitride film, a polycrystalline film, or the like in addition to the silicon oxide film on a surface thereof. The base substrate may be a base substrate having, on a wiring board having a predetermined wiring, an inorganic insulating film such as silicon oxide, glass, or silicon nitride; a film mainly containing polysilicon, Al, Cu, Ti, TiN, W, Ta, TaN, or the like; and the like.

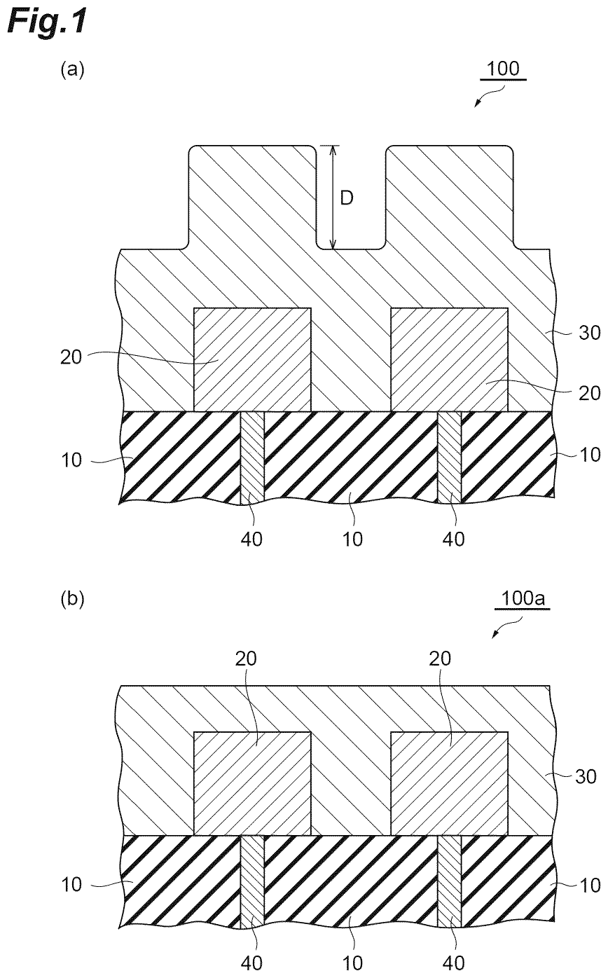

Hereinafter, as an example of a process including the polishing method of the present embodiment, a process of forming an ILD film (interlayer insulating film) structure by CMP will be described. FIG. 1 is a schematic cross-sectional view illustrating the process of polishing an ILD film, and shows the process of forming an ILD film between wirings. FIG. 1(a) is a schematic cross-sectional view illustrating abase substrate before polishing. FIG. 1(b) is a schematic cross-sectional view illustrating the base substrate after polishing.

As illustrated in FIG. 1(a), in a base substrate 100 before polishing, a wiring 20 is formed via an ILD film 10 on a lower substrate (not illustrated) having a predetermined lower wiring (not illustrated), and a silicon oxide film 30 is formed so as to cover this wiring 20. Since the silicon oxide film 30 is formed on the ILD film 10 on which the wiring 20 is formed, portions on the wiring 20 are higher than other portions, thereby resulting in a step height D on the surface of the silicon oxide film 30. The wiring 20 is connected to a lower wiring or the like by a contact plug 40 formed so as to penetrate the ILD film 10.

In the process of forming the ILD film structure, in order to eliminate the step height D, partially protruding unnecessary parts on the surface of the silicon oxide film 30 are preferentially removed by CMP. To polish the silicon oxide film 30, the base substrate 100 is disposed on a polishing member so that the surface of the silicon oxide film 30 and the polishing member are in contact with each other, and the surface of the silicon oxide film 30 is polished by this polishing member. More specifically, the surface to be polished (surface) side of the silicon oxide film 30 is pressed against a polishing member of a polishing platen, and the silicon oxide film 30 is polished by relatively moving the surface to be polished and the polishing member while the polishing liquid is supplied therebetween. Thereby, the step height D is eliminated, and finally, as illustrated in FIG. 1(b), the height of the portion of the wiring 20 on the surface of the silicon oxide film 30 and the height of the other portions become almost the same, and a base substrate 100a having the silicon oxide film 30 (ILD film) with a flat surface is obtained.

As the polishing apparatus used for polishing, for example, an apparatus provided with a holder for holding a base substrate, a polishing platen to which a polishing pad is attached, and a means for supplying a polishing liquid onto the polishing pad can be used. Examples of the polishing apparatus include polishing apparatuses (Model Nos.: EPO-111, EPO-222, F-REX200, and F-REX300) manufactured by EBARA CORPORATION and polishing apparatuses (trade name: Mirra3400 and Reflexion) manufactured by Applied Materials, Inc. The constituent material of the polishing pad is not particularly limited, and for example, a general nonwoven fabric, foamed polyurethane, a porous fluororesin, or the like can be used. Furthermore, the polishing pad may be subjected to groove processing by which the polishing liquid accumulates thereon.

The polishing conditions are not particularly limited, but the rotational speed of the polishing platen may be 200 min⁻¹ or less from the viewpoint of suppressing the flying-off of the base substrate. The pressure (processing load) applied to the base substrate may be 100 kPa or less from the viewpoint of easily suppressing the polishing scratches on the polished surface. The polishing liquid may be continuously supplied to the polishing pad with a pump or the like during polishing. The amount supplied for this is not limited, but the surface of the polishing pad may be always covered with the polishing liquid. The base substrate may be sufficiently washed in running water after the completion of polishing, then dried after removing droplets, which have attached onto the base substrate, with the use of a spin dry or the like.

Polishing as described above allows irregularities on the surface to be eliminated, and thereby a smooth surface across the entire base substrate can be obtained. Furthermore, by repeating the steps of forming a film and polishing this film a predetermined number of times, a structure having desired number of layers can be produced.

The base substrate (structure) obtained in this way can be used as various electronic components. Specific examples of the electronic components include semiconductor elements; optical glass for a photomask, a lens, and a prism; inorganic conductive films of ITO or the like; optical integrated circuits/optical switching elements/optical waveguides constituted with glass and crystalline materials; end faces of optical fibers; optical single crystals such as scintillators; solid laser single crystals; sapphire substrates for blue laser LED; semiconductor single crystals of SiC, GaP, GaAs, and the like; glass substrates for magnetic discs; and magnetic heads.

### <Manufacturing Method and the Like>

A method for manufacturing a component of the present embodiment includes a component manufacturing step of obtaining a component by using a base substrate (polished member) polished by the polishing method of the present embodiment. A component of the present embodiment is a component obtained by the method for manufacturing a component of the present embodiment. The component of the present embodiment is not particularly limited, and may be an electronic component (for example, a semiconductor component such as a semiconductor package), may be a wafer (for example, a semiconductor wafer), and may be a chip (for example, a semiconductor chip). As an embodiment of the method for manufacturing a component of the present embodiment, in a method for manufacturing an electronic component of the present embodiment, an electronic component is obtained by using a base substrate polished by the polishing method of the present embodiment. As an embodiment of the method for manufacturing a component of the present embodiment, in a method for manufacturing a semiconductor component of the present embodiment, a semiconductor component (for example, a semiconductor package) is obtained by using a base substrate polished by the polishing method of the present embodiment. The method for manufacturing a component of the present embodiment may include a polishing step of polishing a base substrate by the polishing method of the present embodiment before the component manufacturing step.

The method for manufacturing a component of the present embodiment may include, as an embodiment of the component manufacturing step, an individually dividing step of individually dividing a base substrate (polished member) polished by the polishing method of the present embodiment. The individually dividing step may be, for example, a step of dicing a wafer (for example, a semiconductor wafer) polished by the polishing method of the present embodiment to obtain chips (for example, semiconductor chips). As an embodiment of the method for manufacturing a component of the present embodiment, the method for manufacturing an electronic component of the present embodiment may include a step of obtaining an electronic component (for example, a semiconductor component) by individually dividing a base substrate polished by the polishing method of the present embodiment. As an embodiment of the method for manufacturing a component of the present embodiment, the method for manufacturing a semiconductor component of the present embodiment may include a step of obtaining a semiconductor component (for example, a semiconductor package) by individually dividing a base substrate polished by the polishing method of the present embodiment.

The method for manufacturing a component of the present embodiment may include, as an embodiment of the component manufacturing step, a connecting step of connecting (for example, electrically connecting) a base substrate (polished member) polished by the polishing method of the present embodiment to other body to be connected. The body to be connected that is connected to the base substrate polished by the polishing method of the present embodiment is not particularly limited, may be a base substrate polished by the polishing method of the present embodiment, and may be a body to be connected different from the base substrate polished by the polishing method of the present embodiment. In the connecting step, the base substrate and the body to be connected may be directly connected to each other (connected in a state where the base substrate and the body to be connected are in contact with each other), and the base substrate and the body to be connected may be connected via other member (such as a conductive member). The connecting step can be performed before the individually dividing step, after the individually dividing step, or before and after the individually dividing step.

The connecting step may be a step of connecting a polished surface of a base substrate polished by the polishing method of the present embodiment to a body to be connected, and may be a step of connecting a connection surface of a base substrate polished by the polishing method of the present embodiment to a connection surface of a body to be connected. The connection surface of the base substrate may be a polished surface that is polished by the polishing method of the present embodiment. A connection body having the base substrate and the connected body can be obtained by the connecting step. In the connecting step, in a case where the connection surface of the base substrate has a metal portion, the body to be connected may be connected to the metal portion. In the connecting step, in a case where the connection surface of the base substrate has a metal portion and the connection surface of the body to be connected has a metal portion, the metal portions may be connected to each other. The metal portion may contain copper.

A device (for example, an electronic device such as a semiconductor device) of the present embodiment has at least one selected from the group consisting of the base substrate polished by the polishing method of the present embodiment and the component of the present embodiment.

### EXAMPLES

Hereinafter, the present disclosure will be further specifically described by means of Examples; however, the present disclosure is not limited to these Examples.

### <Preparation of Cerium Oxide Powder>

40 kg of cerium carbonate hydrate was divided and placed in ten of alumina containers, respectively, and fired at 830° C. for 2 hours in air to obtain 20 kg of yellowish-white powder in total. The phase identification of this powder was performed by an X-ray diffraction method, and it was confirmed that this powder contained polycrystalline cerium oxide. The particle diameter of the powder obtained by firing was observed with a SEM and was found to be in a range of 20 to 100 μm. Next, 20 kg of the cerium oxide powder was subjected to dry pulverization using a jet mill to obtain a cerium oxide powder. The specific surface area of the cerium oxide powder after pulverization was 9.4 m²/g. The measurement of the specific surface area was performed by the BET method.

### <Preparation of Slurry>

15.0 kg of the cerium oxide powder obtained above and 84.85 kg of deionized water were placed in a container and mixed. Next, 0.375 kg of an aqueous solution of ammonium polyacrylate (concentration: 40% by mass, molecular weight: about 10000) or 0.15 kg of ammonium dihydrogen phosphate (ADP) was added as the dispersant and then stirred for 10 minutes to obtain a cerium oxide mixed liquid. This cerium oxide mixed liquid was sent to another container over 30 minutes. Meanwhile, in the sending pipe, the cerium oxide mixed liquid was irradiated with ultrasonic wave at an ultrasonic wave frequency of 400 kHz.

A 500 g±5 g portion of the aforementioned cerium oxide mixed liquid conveyed with the ultrasonic irradiation was divided into each of four 500 mL polyethylene containers. The cerium oxide mixed liquid in each container was subjected to centrifugal separation for 2 minutes under conditions with an outer peripheral centrifugal force of 500 G. After centrifugal separation, the supernatant fraction in the container was collected. The supernatant fractions collected from the four containers were mixed together to obtain a slurry. The slurry contained about 6.0% by mass of cerium oxide particles on the basis of the total mass of the slurry.

The slurry was diluted with pure water so that the content of the abrasive grains having a scattering intensity in a range suitable for measurement was obtained, thereby obtaining a sample for particle diameter measurement. For this sample, the average particle diameter of the abrasive grains was measured using a laser diffraction/scattering particle size distribution measuring device (manufactured by MicrotracBEL Corp., trade name: Microtrac MT3300EXII), and as a result, the average particle diameter of the abrasive grains was 140 nm.

### <Preparation of Polishing Liquid for CMP>

The aforementioned slurry, each additive, and deionized water were mixed in the procedure below to obtain a polishing liquid having the composition (balance: deionized water) of each table below (note that, in Comparative Examples 1, 2, and 6, no additive other than the dispersant mixed when the aforementioned slurry was prepared was used) In the table, “THEED” means 2,2′,2″,2′″-ethylenedinitrilotetraethanol. Each polishing liquid contains 1 part by mass of ammonium polyacrylate or 1 part by mass of ammonium dihydrogen phosphate (ADP) with respect to 100 parts by mass of the abrasive grains as the dispersant mixed when the aforementioned slurry was prepared.

Specifically, each additive was dissolved in deionized water to obtain an additive solution. Next, the aforementioned slurry and the additive solution were mixed in equal amounts and then stirred for 10 minutes to obtain a stock solution for a polishing liquid in a concentrated state containing 5.00% by mass of abrasive grains based on the total mass. The stock solution for a polishing liquid contains the abrasive grains and the additive at 10-fold amounts with respect to 0.50% by mass of the content of the abrasive grains of the final polishing liquid, and contains the abrasive grains and the additive at 2.5-fold amounts with respect to 2.00% by mass of the content of the abrasive grains of the final polishing liquid.

Then, the stock solution for a polishing liquid was diluted 10-fold with deionized water to obtain each polishing liquid of Examples 1 to 4, 13 to 14, and 21 to 26 and Comparative Examples 1 and 6. Furthermore, the stock solution for a polishing liquid was diluted 2.5-fold with deionized water to obtain each polishing liquid of Examples 5 to 12 and 15 to 20 and Comparative Examples 2 to 5. The average particle diameter of the abrasive grains in the polishing liquid of each Example, as measured by the same method as for the average particle diameter of the abrasive grains in the aforementioned slurry, was equivalent to the average particle diameter of the abrasive grains in the aforementioned slurry.

### <Zeta Potential Measurement>

An adequate amount of the polishing liquid was charged into trade name “DelsaNano C” manufactured by Beckman Coulter, Inc. and measurement was performed twice at 25° C. The average value of the displayed zeta potentials was obtained as the zeta potential. The zeta potential of the abrasive grains in each of Examples and Comparative Examples was negative as shown in each table.

### <pH Measurement>

The pH of the polishing liquid was measured under the following conditions. The results are shown in each table.
Measurement temperature: 25° C.
Measuring apparatus: trade name: Model (D-71) manufactured by HORIBA, Ltd.
Measurement method: calibrating the pH meter by three points using a pH standard solution (pH: 4.01) of a phthalate, a pH standard solution (pH: 6.86) of a neutral phosphate, and a pH standard solution (pH: 9.18) of a borate as pH standard solutions, then putting an electrode of the pH meter in the polishing liquid, and measuring the pH with the above-described measuring apparatus at the time after 2 min or more elapsed and the pH became stable.

### <Evaluation of Dispersion Stability of Abrasive Grains>

The aforementioned polishing liquid immediately after preparation was left to stand still for 1 week (168 hours), and the average particle diameters of the abrasive grains after a lapse of 3 hours and a lapse of 1 week immediately after preparation were measured by the same method as for the average particle diameter of the abrasive grains in the aforementioned slurry. As the change rate of the average particle diameter of the abrasive grains after a lapse of 3 hours or 1 week, “[(average particle diameter after a lapse of 3 hours or 1 week in the polishing liquid−average particle diameter of the abrasive grains in the aforementioned slurry)/average particle diameter of the abrasive grains in the aforementioned slurry]×100” was calculated. A case where the change rate of the average particle diameter of the abrasive grains after a lapse of 1 week (and the change rate of the average particle diameter of the abrasive grains after a lapse of 3 hours) was 4% or less was determined as “A”, a case where the change rate of the average particle diameter of the abrasive grains after a lapse of 1 week was more than 4% but the change rate of the average particle diameter of the abrasive grains after a lapse of 3 hours was 4% or less was determined as “B”, and a case where the change rate of the average particle diameter of the abrasive grains after a lapse of 3 hours was more than 4% was determined as “C”. The results are shown in each table.

### <Evaluation of Polishing Properties>

### (Preparation of Wafer for Evaluation)

As a blanket wafer (BKW), a ϕ200 mm wafer with no pattern having a silicon oxide film (SiO₂, initial film thickness: 1000 nm) on a surface thereof and a ϕ200 mm wafer with no pattern having a silicon nitride film (SiN, initial film thickness: 200 nm) on a surface thereof were prepared.

As a pattern wafer (PTW), a test patterned wafer (Model No.: Sematech864, manufactured by ADVANTEC CO., LTD., ϕ200 mm) of a silicon oxide film (initial film thickness: 600 nm) having concavo-convex patterns on a surface thereof was prepared. The convex portion (Line portion) has an initial step height of 500 nm higher than the concave portion (Space portion), and the convex portion has a silicon nitride film (initial film thickness: 140 nm) as a base stopper of a silicon oxide film, assuming the evaluation of shallow trench isolation. The pattern wafer has a plurality of die units of 20 mm×20 mm, and each die unit has a plurality of unit areas of 4 mm×4 mm. The pattern wafer has, as the unit area of 4 mm×4 mm, a region with a parallel line pattern in which the pitch is 100 μm width, and Line/Space (L/S) is 10 μm/90 μm (density of convex portion: 10%) to 90 μm/10 μm (density of convex portion: 90%) at 10 μm intervals.

### (Polishing Procedure)

The aforementioned wafer for evaluation was polished using a polishing apparatus (manufactured by Applied Materials, Inc., trade name: Mirra3400). The aforementioned wafer for evaluation was set in a holder having an adsorption pad for attachment of the base substrate. A polishing pad made of a porous urethane resin (K-groove, manufactured by DuPont (Dow), Model No.: IC-1010) was attached to a polishing platen having a diameter of 500 mm.

The aforementioned holder was placed on the polishing pad with the surface to be polished of the aforementioned wafer for evaluation facing downward. The inner tube pressure, the retainer ring pressure, and the membrane pressure were set to 14 kPa, 21 kPa, and 14 kPa, respectively.

Then, while adding dropwise the aforementioned polishing liquid (except for Comparative Examples 3 to 5) onto the polishing pad attached to the aforementioned polishing platen at a flow rate of 200 mL/min, the polishing platen and the wafer for evaluation were rotated at 93 min⁻¹ and 87 min⁻¹, respectively, for polishing the surface to be polished. In the blanket wafer, polishing was performed for 30 seconds. In the pattern wafer, a time when the silicon nitride film as the base of the silicon oxide film was not exposed on the convex portion in a region with L/S=20 μm/80 μm was set in a range of 20 to 60 seconds as the polishing time according to the polishing rate evaluated on the blanket wafer, and polishing was performed for such polishing time. Subsequently, the polished wafer for evaluation was thoroughly washed with pure water using a PVA brush (polyvinyl alcohol brush) and then dried.

### (Evaluation of Polishing Rate)

A light interference type film thickness measuring apparatus (manufactured by Nanometrics Japan Ltd., trade name: AFT-5100) was used to measure a change amount in film thickness of the film to be polished before and after polishing as described below, thereby obtaining a polishing rate. Furthermore, the polishing rate ratio (PTW/BKW) of silicon oxide of the convex portion of the pattern wafer with respect to silicon oxide of the blanket wafer was calculated. The results are shown in each table.

In the blanket wafer, the change amount in film thickness was measured at a total of 41 (20 points on both sides of the center point) measuring points, including the center point of the wafer and respective points at 5 mm intervals from the center point in the diameter direction (the next measuring point from the measuring point 95 mm from the center was at a location 97 mm from the center). The change amount in film thickness during a polishing time of 30 seconds was measured at these 41 points, and an average value thereof was obtained as the polishing rate for the blanket wafer.

In the pattern wafer, the change amount in film thickness of the convex portion in a region with L/S=20 μm/80 μm was measured to obtain the polishing rate for the pattern wafer. In the central die unit (20 mm×20 mm) of the pattern wafer, the change amount in film thickness at one central part of one unit area (4 mm×4 mm) with L/S=20 μm/80 μm was measured.

TABLE 1

| | | Example | | | | | | | | | | | | |
|---|---|---|---|---|---|---|---|---|---|---|---|---|---|---|
| | | 1 | 2 | 3 | 4 | 5 | 6 | 7 | 8 | 9 | 10 | 11 | 12 | 13 |
| Abrasive | Zeta | −50 | −50 | −50 | −50 | −60 | −55 | −60 | −55 | −55 | −50 | −50 | −50 | −55 |
| grains | potential | to −45 | to −45 | to −45 | to −45 | to −55 | to −50 | to −55 | to −50 | to −50 | to −45 | to −45 | to −45 | to −50 |
| | [mV] | | | | | | | | | | | | | |
| | Content | 0.50 | | | | 2.00 | | | | | | | | 0.50 |
| | [mass %] | | | | | | | | | | | | | |
| Dispersant | Type | Ammonium polyacrylate | | | | | | | | | | | | ADP |
| 4-Pyrone- | Type | Maltol | | | Kojic | Maltol | | | | | | Kojic acid | | Maltol |
| based | | | | | acid | | | | | | | | | |
| compound | Content | 0.05 | 0.1 | 0.2 | 0.1 | 0.005 | 0.01 | 0.01 | 0.05 | 0.1 | 0.2 | 0.1 | 0.2 | 0.05 |
| | [mass %] | | | | | | | | | | | | | |
| THEED | Content | — | — | — | — | — | — | 0.009 | — | — | — | — | — | — |
| | [mass %] | | | | | | | | | | | | | |
| pH | | 7.0 | 7.0 | 6.8 | 6.5 | 8.0 | 7.8 | 8.2 | 7.7 | 7.2 | 6.8 | 7.0 | 6.7 | 7.1 |
| Dispersion stability | | A | A | A | A | A | A | A | A | A | A | A | A | B |
| of abrasive grains | | | | | | | | | | | | | | |
| Polishing | BKW:SiO₂ | 145.8 | 119.4 | 83.7 | 47.9 | 276.6 | 262.8 | 232.0 | 294.3 | 206.0 | 204.0 | 153.0 | 109.0 | 119.0 |
| rate | BKW:SiN | 5.3 | 4.7 | 4.2 | 4.6 | 35.9 | 13.4 | 15.9 | 6.4 | 6.4 | 6.7 | 5.0 | 4.0 | 6.0 |
| [nm/min] | PTW:SiO₂ | 317.5 | 290.5 | 244.7 | 252.2 | 306.8 | 364.0 | 320.9 | 600.5 | 385.0 | 360.0 | 392.0 | 344.0 | 201.0 |
| Polishing | PTW/BKW | 2.18 | 2.43 | 2.92 | 5.27 | 1.11 | 1.39 | 1.38 | 2.04 | 1.87 | 1.76 | 2.56 | 3.16 | 1.69 |
| rate ratio | (SiO₂) | | | | | | | | | | | | | |

TABLE 2

| | | Example | | | | | | | |
|---|---|---|---|---|---|---|---|---|---|
| | | 14 | 15 | 16 | 17 | 18 | 19 | 20 | 21 |
| Abrasive grains | Zeta | −45 | −55 | −50 | −45 | −50 | −45 | −45 | −45 |
| | potential | to −40 | to −50 | to −45 | to −40 | to −45 | to −40 | to −40 | to −40 |
| | [mV] | | | | | | | | |
| | Content | 0.50 | 2.00 | | | | | | 0.50 |
| | [mass %] | | | | | | | | |
| Dispersant | Type | Ammonium polyacrylate | | | | | | | ADP |
| Picolinic acid | Content | 0.010 | 0.005 | 0.010 | 0.050 | 0.050 | 0.055 | 0.100 | 0.010 |
| | [mass %] | | | | | | | | |
| THEED | Content | — | — | — | — | 0.060 | — | 0.076 | — |
| | [mass %] | | | | | | | | |
| pH | | 5.5 | 7.3 | 6.8 | 5.5 | 6.5 | 5.4 | 5.7 | 5.6 |
| Dispersion stability | | A | A | A | A | A | B | A | A |
| of abrasive grains | | | | | | | | | |
| Polishing rate | BKW:SiO₂ | 109.0 | 392.0 | 427.0 | 602.0 | 225.0 | 620.0 | 279.0 | 171.8 |
| [nm/min] | BKW:SiN | 23.9 | 39.0 | 61.0 | 83.1 | 33.0 | 84.0 | 58.0 | 32.7 |
| | PTW:SiO₂ | 268.4 | 379.9 | 478.3 | 926.0 | 468.0 | 934.0 | 485.0 | 227.0 |
| Polishing rate | PTW/BKW | 2.46 | 0.97 | 1.12 | 1.54 | 2.08 | 1.51 | 1.74 | 1.32 |
| ratio | (SiO₂) | | | | | | | | |

TABLE 3

| | | Example | | | | |
|---|---|---|---|---|---|---|
| | | 22 | 23 | 24 | 25 | 26 |
| Abrasive grains | Zeta | −50 | −45 | −50 | −50 | −45 |
| | potential | to −45 | to −40 | to −45 | to −45 | to −40 |
| | [mV] | | | | | |
| | Content | 0.50 | | | | |
| | [mass %] | | | | | |
| Dispersant | Type | Ammonium polyacrylate | | | | |
| 3-Hydroxypicolinic | Content | 0.005 | 0.010 | — | — | — |
| acid | [mass %] | | | | | |
| 5-Aminopicolinic | Content | — | — | 0.005 | 0.010 | 0.050 |
| acid | [mass %] | | | | | |
| pH | | 6.7 | 5.5 | 6.8 | 6.2 | 5.5 |
| Dispersion stability | | A | A | A | A | A |
| of abrasive grains | | | | | | |
| Polishing rate | BKW:SiO₂ | 272.3 | 149.8 | 301.0 | 246.7 | 213.4 |
| [nm/min] | BKW:SiN | 11.3 | 19.7 | 11.1 | 15.9 | 55.4 |
| | PTW:SiO₂ | 221.9 | 358.0 | 228.5 | 323.1 | 408.6 |
| Polishing rate | PTW/BKW | 0.81 | 2.39 | 0.76 | 1.31 | 1.91 |
| ratio | (SiO₂) | | | | | |

TABLE 4

| | | Comparative Example | | | | | |
|---|---|---|---|---|---|---|---|
| | | 1 | 2 | 3 | 4 | 5 | 6 |
| Abrasive grains | Zeta | −60 | −60 | <−35 | <−25 | <−25 | −55 |
| | potential | to −55 | to −55 | | | | to −50 |
| | [mV] | | | | | | |
| | Content | 0.50 | 2.00 | | | | 0.50 |
| | [mass %] | | | | | | |
| Dispersant | Type | Ammonium polyacrylate | | | | | ADP |
| Picolinic acid | Content | — | — | 0.080 | 0.100 | 0.200 | — |
| | [mass %] | | | | | | |
| pH | | 8.2 | 8.3 | 4.9 | 4.5 | 4.0 | 7.7 |
| Dispersion stability | | A | A | C | C | C | A |
| of abrasive grains | | | | | | | |
| Polishing rate | BKW:SiO₂ | 152.0 | 297.0 | | | | 178.4 |
| [nm/min] | BKW:SiN | 15.0 | 57.0 | | | | 37.0 |
| | PTW:SiO₂ | 94.0 | 184.0 | | | | 120.0 |
| Polishing rate | PTW/BKW | 0.62 | 0.62 | | | | 0.67 |
| ratio | (SiO₂) | | | | | | |

### REFERENCE SIGNS LIST

10: ILD film, 20: wiring, 30: silicon oxide film, 40: contact plug, 100, 100a: base substrate, D: step height.

1. A polishing liquid for CMP, comprising: abrasive grains; an additive; and water, wherein
the abrasive grains include cerium-based particles,
a zeta potential of the abrasive grains is negative,
the additive includes (A1) a 4-pyrone-based compound represented by General Formula (1) below, and
a pH is 5.0 or more: 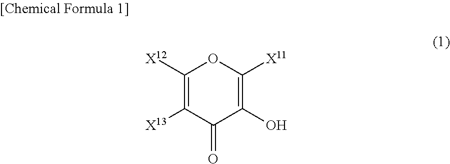
[in the formula, X¹¹, X¹², and X¹³ are each independently a hydrogen atom or a monovalent substituent.]

2. The polishing liquid for CMP according to claim 1, wherein the component (A1) includes at least one selected from the group consisting of 3-hydroxy-2-methyl-4-pyrone, 5-hydroxy-2-(hydroxymethyl)-4-pyrone, and 2-ethyl-3-hydroxy-4-pyrone.

3. The polishing liquid for CMP according to claim 1, wherein a content of the component (A1) is 0.001 to 5% by mass.

4. The polishing liquid for CMP according to claim 1, wherein the additive further includes (B) a compound having two or more nitrogen atoms to which a hydroxyalkyl group is bonded.

5. The polishing liquid for CMP according to claim 4, wherein the component (B) includes an ethylenedinitrilotetraethanol.

6. The polishing liquid for CMP according to claim 1, wherein the pH is 8.0 or less.

7. A polishing liquid for CMP, comprising: abrasive grains; an additive; and water, wherein
the abrasive grains include cerium-based particles,
a zeta potential of the abrasive grains is negative,
the additive includes (A2) a picolinic acid compound, and
a pH is 5.0 or more.

8. The polishing liquid for CMP according to claim 7, wherein the component (A2) includes picolinic acid.

9. The polishing liquid for CMP according to claim 7, wherein the component (A2) includes hydroxypicolinic acid.

10. The polishing liquid for CMP according to claim 7, wherein the component (A2) includes aminopicolinic acid.

11. The polishing liquid for CMP according to claim 7, wherein a content of the component (A2) is 0.001 to 5% by mass.

12. The polishing liquid for CMP according to claim 7, wherein the additive further includes (B) a compound having two or more nitrogen atoms to which a hydroxyalkyl group is bonded.

13. The polishing liquid for CMP according to claim 12, wherein the component (B) includes an ethylenedinitrilotetraethanol.

14. The polishing liquid for CMP according to claim 7, wherein the pH is 8.0 or less.

15. A polishing liquid set for CMP, comprising:
constituent components of the polishing liquid for CMP according to claim 1, separately stored as a first liquid and a second liquid, wherein
the first liquid contains the abrasive grains and water, and
the second liquid contains at least one of the additives, and water.

16. A polishing method comprising a step of polishing a surface to be polished by using the polishing liquid for CMP according to claim 1.

17. The polishing method according to claim 16, wherein the surface to be polished contains silicon oxide.

18. A polishing method comprising a step of polishing a surface to be polished by using a polishing liquid for CMP obtained by mixing the first liquid and the second liquid of the polishing liquid set for CMP according to claim 15.

19. The polishing method according to claim 18, wherein the surface to be polished contains silicon oxide.

20. A polishing liquid set for CMP, comprising:
constituent components of the polishing liquid for CMP according to claim 7, separately stored as a first liquid and a second liquid, wherein
the first liquid contains the abrasive grains and water, and
the second liquid contains at least one of the additives, and water.

21. A polishing method comprising a step of polishing a surface to be polished by using the polishing liquid for CMP according to claim 7.
